(19) United States
(12) Patent Application Publication
(10) Pub. No.: US 2026/0118903 A1
(43) Pub. Date: Apr. 30, 2026

(54) LOW-NOISE AND FAST-SETTLING REFERENCE VOLTAGE GENERATOR FOR CAPACITIVE DIGITAL-TO-ANALOG CONVERTER

(71) Applicant: MEDIATEK INC., Hsinchu City (TW)

(72) Inventors: Chi-Heng CHUNG, Hsinchu City (TW); Chuan-Hung HSIAO, Hsinchu City (TW); Sujith Kumar BILLA, Hsinchu City (TW); Sung-Han WEN, Hsinchu City (TW)

(21) Appl. No.: 19/282,149

(22) Filed: Jul. 28, 2025

Related U.S. Application Data
(60) Provisional application No. 63/713,091, filed on Oct. 29, 2024.

(51) Int. Cl. G05F 3/24

(52) U.S. Cl. CPC G05F 3/242

(57) ABSTRACT

A reference voltage generator for capacitive digital-to-analog converter (CDAC) is shown. The reference voltage generator has a low-pass circuit and a charge compensation circuit. The low-pass circuit has an input terminal receiving a reference voltage, and an output terminal coupled to a reference input terminal of a CDAC. The charge compensation circuit is coupled to the reference input terminal of the CDAC in a first phase to compensate for charge losses of the CDAC, and is coupled to the reference voltage in a second phase to be charged by the reference voltage. In the first phase, the charge compensation circuit provides a reinforced voltage to the reference input terminal of the CDAC, and the reinforced voltage is greater than the reference voltage. A stable voltage, therefore, is provided to the reference input terminal of the CDAC.

### CROSS REFERENCE TO RELATED APPLICATIONS

This application claims the benefit of U.S. Provisional Application No. 63/713,091, filed Oct. 29, 2024, the entirety of which is incorporated by reference herein.

### BACKGROUND OF THE INVENTION

### Field of the Invention

The present invention relates to a reference voltage generator, and, in particular, it relates to a reference voltage generator for a capacitive digital-to-analog converter (CDAC).

### Description of the Related Art

Delta-sigma (ΔΣ) modulation is an oversampling method for encoding signals, which may be used to implement delta-sigma analog-to-digital converters (ADCs) or digital-to-analog converters (DAC).

FIG. 1A depicts a block diagram of a delta-sigma ADC, wherein a control loop is formed by an integrator 102, a quantizer 104, and a capacitive digital-to-analog converter (CDAC) 106. An analog input Vin is converted into its digital representation Dout. For audio applications, the quantization noise, en, is suppressed, but a reference noise, Vn, in the audio band cannot be eliminated.

FIG. 1B illustrates the circuit of the CDAC 106, which is a switched capacitor circuit controlled by control bits Din. According to the control bits Din, the capacitors of the switched capacitor circuit are switched to be coupled to the power ground Vss, or a reference input Vref_dac (which is a reference voltage Vref plus the reference noise Vn). As mentioned in FIG. 1A, the reference noise, Vn, in the audio band is a thorny issue. Finding a way to provide a stable reference input Vref_dac to the CDAC 106 is important in this technological field.

### BRIEF SUMMARY OF THE INVENTION

A reference voltage generator providing a stable reference input, Vref, DAC, for a capacitive digital-to-analog converter (CDAC) is shown.

A reference voltage generator in accordance with an exemplary embodiment of the disclosure includes a low-pass circuit, and a first charge compensation circuit. The low-pass circuit has an input terminal receiving a reference voltage and an output terminal coupled to the first reference input terminal of the first capacitive digital-to-analog converter (CDAC). The first charge compensation circuit is coupled to the first reference input terminal of the first CDAC in the first phase to compensate for charge losses of the first CDAC, and coupled to the reference voltage in the second phase to be charged by the reference voltage. The first charge compensation circuit coupled to the first reference input terminal of the first CDAC in the first phase provides a first reinforced voltage to the first reference input terminal of the first CDAC, and the first reinforced voltage is greater than the reference voltage.

In this manner, the charges required by the first CDAC are supplied by the first charge compensation circuit, and the reference voltage is not affected by the first CDAC and kept stable.

In an exemplary embodiment, the first charge compensation circuit comprises a plurality of capacitor networks, each of which corresponds to one control bit of the first CDAC, which has a plurality of control bits. In response to assertion of one control bit of the first CDAC, the corresponding capacitor network is coupled to the first reference input terminal of the first CDAC, and then is coupled back to the reference voltage.

In this manner, the charge compensation capability of first charge compensation circuit adapts to the charge losses of the first CDAC.

In an exemplary embodiment, the low-pass circuit comprises a reference capacitor. The reference capacitor is charged by the reference voltage. The reference capacitor is further coupled to the first reference input terminal of the first CDAC.

In an exemplary embodiment, the low-pass circuit further comprises a reference resistor. The reference resistor couples the reference voltage to the reference capacitor, and the reference resistor and the reference capacitor form a low-pass filter.

In an exemplary embodiment, a multiple channel structure is shown. The output terminal of the low-pass circuit is further coupled to a second reference input terminal of a second CDAC. The reference voltage generator further comprises a second charge compensation circuit that is operative to be coupled to the second reference input terminal of the second CDAC to compensate for charge losses of the second CDAC. Similar to the first charge compensation circuit, the second charge compensation circuit is also charged by the reference voltage. In such a design, the CDACs in the different channels are compensated by the different charge compensation circuits, but the same lo-pass circuit is shared by the different CDACs.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A depicts a block diagram of a delta-sigma ADC;

FIG. 1B illustrates the circuit of the CDAC 106;

FIG. 2 illustrates a reference voltage generator 200 for a capacitive digital-to-analog converter (CDAC) 202 in accordance with an exemplary embodiment of the disclosure;

FIG. 3 illustrates the DEM technology and the chopping technology by examples of Din=0 and Din=4;

FIG. 4 illustrates the circuit details of the reference voltage generator 200 in accordance with an exemplary embodiment of the disclosure;

FIG. 5 illustrates the details of the capacitor networks 402_0 . . . 402_M in accordance with an exemplary embodiment of the disclosure;

FIGS. 6A and 6B illustrate the other structures of the capacitor network in the first phase (ψ1);

FIG. 7 illustrates a reference voltage generator 700 in accordance with an exemplary embodiment of the disclosure; and

FIG. 8 illustrates the details of the capacitor networks 402_0 . . . 402_M in accordance with another exemplary embodiment of the disclosure.

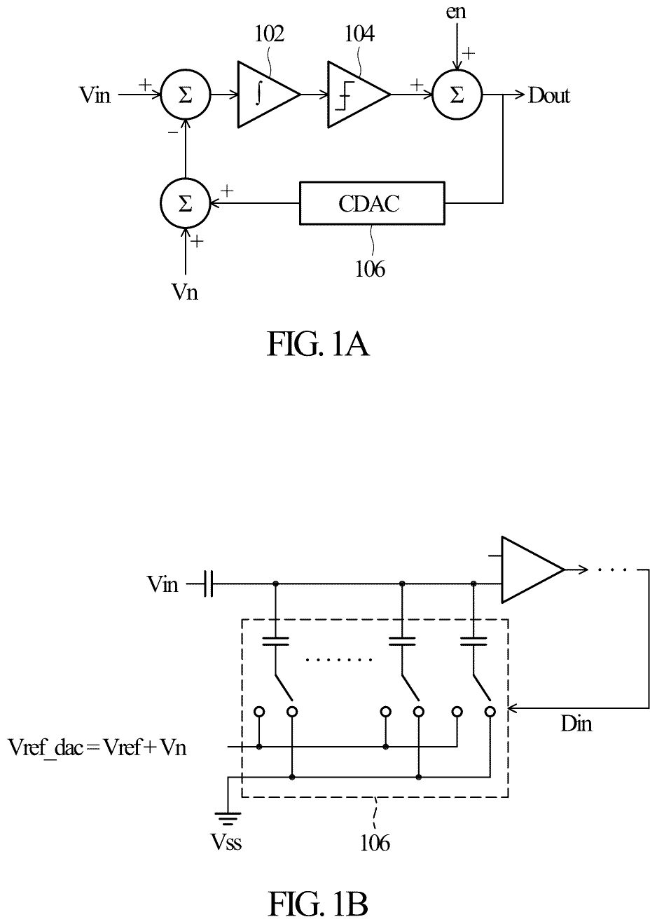

### DETAILED DESCRIPTION OF THE INVENTION

The following description enumerates various embodiments of the disclosure, but is not intended to be limited thereto. The actual scope of the disclosure should be defined according to the claims. The various blocks may be implemented by special circuits. The circuit components may be directly connected to each other without additional components as the circuit illustrated in the figures. Or, there may be some additional components coupled between the illustrated circuit components.

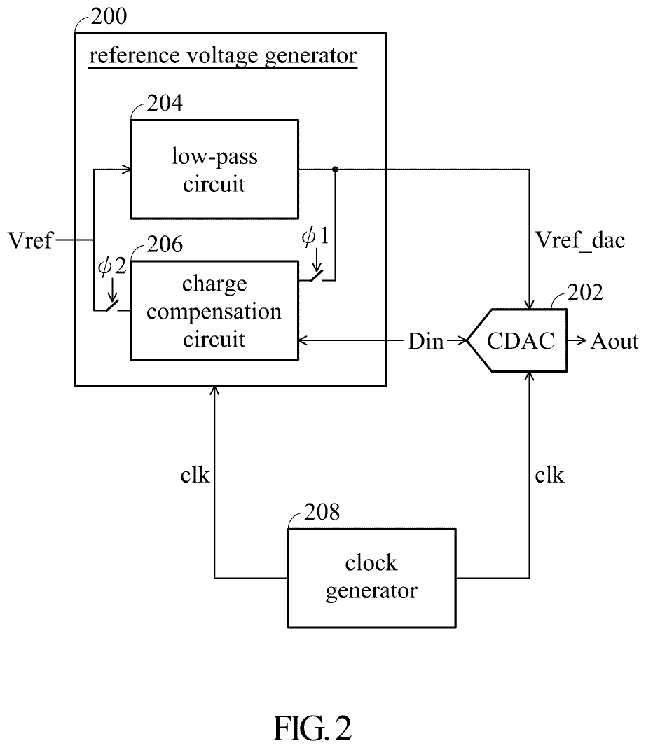

FIG. 2 illustrates a reference voltage generator 200 for a capacitive digital-to-analog converter (CDAC) 202 in accordance with an exemplary embodiment of the disclosure. The reference voltage generator 200 has a low-pass circuit 204 and a charge compensation circuit 206. The low-pass circuit 204 has an input terminal receiving a reference voltage Vref, and an output terminal coupled to a reference input terminal Vref_dac of the CDAC 202. The charge compensation circuit 206 is coupled to the reference input terminal Vref_dac of the CDAC 202 in the first phase ψ1, to compensate for charge losses of the CDAC 202. In the second phase ψ2, the charge compensation circuit 206 is coupled to the reference voltage Vref to be charged by the reference voltage Vref. Specifically, the charge compensation circuit 206 coupled to the reference input terminal Vref_dac of the CDAC 202 in the first phase ψ1 provides a reinforced voltage to the reference input terminal Vref_dac of the CDAC 202. The reinforced voltage is greater than the reference voltage Vref. Therefore, the charge compensation circuit 206 is strong enough to keep the reference input (also labeled as Vref_dac) stable.

In such an architecture, the low-pass circuit 204 provides a dc path to transfer the reference voltage Vref to the reference input terminal Vref_dac of the CDAC 202. The charge losses of the CDAC 202 are compensated by the reinforced voltage (greater than the reference voltage Vref) provided by the charge compensation circuit 206. The charge compensation circuit 206 works as a charge pump. The ripple of the reference input Vref_dac is effectively suppressed, and so that the harmonic distortion (THD) of the device using the CDAC 202 is considerably reduced.

FIG. 2 further shows a clock generator 208 that generates a clock signal clk. The CDAC 202 including a switched capacitor circuit is controlled based on the clock signal clk, to couple the bottom plates (or top plates) of the capacitors (within the switched capacitor circuit) to a power ground Vss or the reference input (Vref_dac) according to control bits Din, and thereby generates an analog output Aout for digital-to-analog conversion from Din to Aout. The first phase (ψ1) starts in response to the rising edge of the clock signal clk, and is followed by the second phase (ψ2). The CDAC 202 loses charges when switching the connection of the switched capacitor circuit at the rising edge of the clock signal, and the charge compensation circuit 206 promptly compensates for the loss in the first phase (ψ1).

The charge compensation circuit 206 may be adaptive to the charge losses of the CDAC 202.

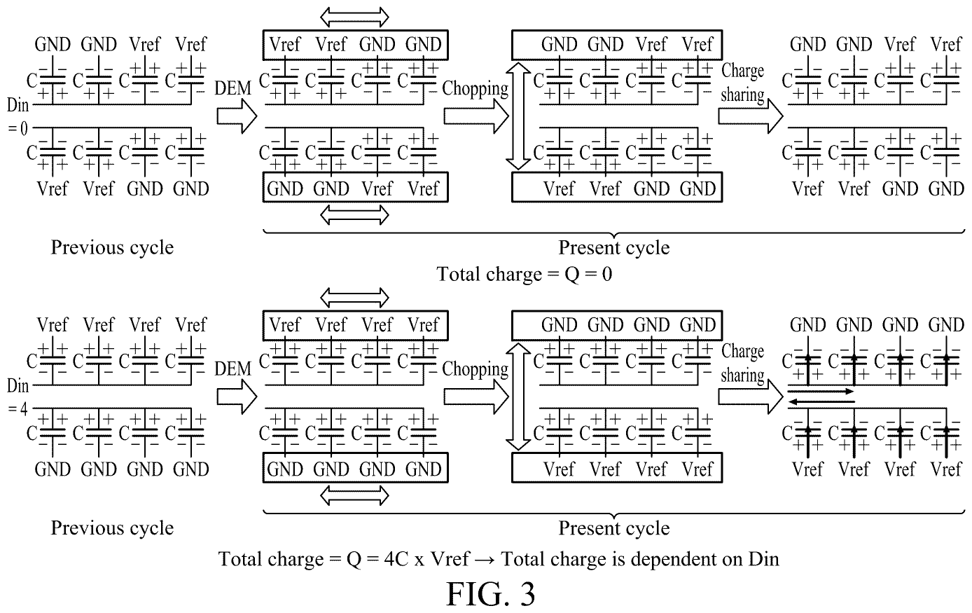

In some exemplary embodiments, the CDAC 202 may use a dynamic element matching (DEM) technology and a chopping technology to deal with the capacitor mismatch problem. According to the DEM technology, the capacitors are used interchangeably in the first direction. According to the chopping technology, the capacitors are used interchangeably in the second direction. FIG. 3 illustrates the DEM technology and the chopping technology by examples of Din=0 and Din=4. Referring to Din=0, after the DEM and chopping in the present cycle, the connection of the capacitors is the same as that of the previous cycle. The amount of flowing charges due to the charge sharing is 0. Referring to Din=4, after the DEM and chopping in the present cycle, the connection of the capacitors is very different from that of the previous cycle. The amount of flowing charges due to the charge sharing is 4C×Vref. FIG. 3 shows that the different Din will lead to the different need of charge compensation. The greater Din may result in the stronger need for charge compensation.

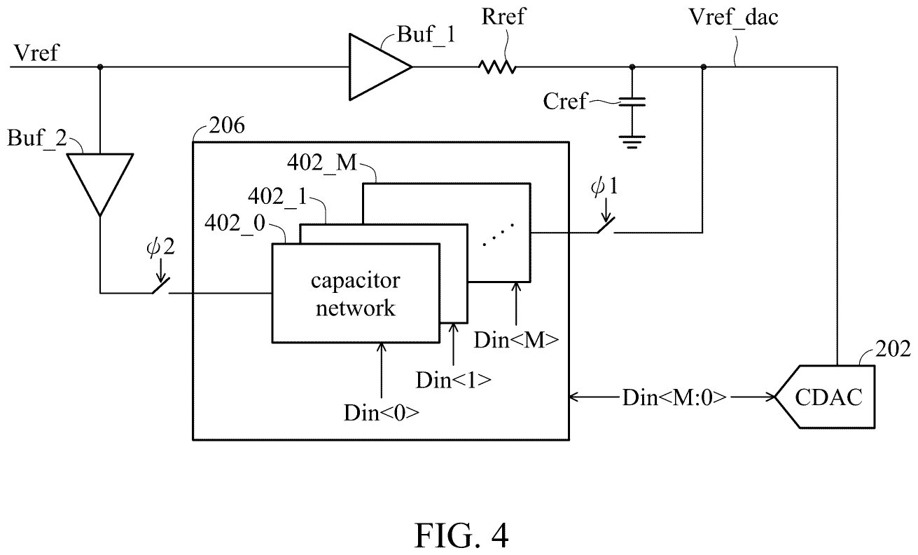

FIG. 4 illustrates the circuit details of the reference voltage generator 200 in accordance with an exemplary embodiment of the disclosure. The charge compensation circuit 206 includes a plurality of capacitor networks (402_0, 402_1, and 402_M). Each capacitor network 402_#(# means a number) corresponds to one control bit Din<#> (i.e., one of the control bits Din<0:M> of the CDAC 202). The more asserted control bits there are, the stronger the need for charge compensation. In response to assertion of one control bit Din<#> of the plurality of control bits Din<0:M> of the CDAC 202, the corresponding capacitor network 402_# is coupled to the reference input terminal Vref_dac of the CDAC 202 (in the first phase ψ1) for charge compensation of the CDAC 202, and then is coupled back to the reference voltage Vref (in the second phase ψ2) to be charged by the reference voltage Vref. The more control bits that are asserted, the more capacitor networks there are coupled to the reference input terminal Vref_dac in the first phase ψ1. An adaptive charge compensation capability is thereby achieved, considerably improving the THD.

In FIG. 4, a reference capacitor Cref is shown to form the low-pass circuit (204). The reference capacitor Cref is charged by the reference voltage Vref, and is further coupled to the reference input terminal Vref_dac of the CDAC 202. The reference capacitor Cref protects the reference input Vref_dac from the noise of the reference voltage Vref, which results in an improved signal-to-noise ratio (SNR). In an exemplary embodiment, the reference capacitor Cref is an off-chip capacitor (not limited thereto), providing capacitance greater than the capacitance of the on-chip capacitors within the capacitor networks 402_0-402_M.

It should be noted that, because the reference input Vref_dac is compensated by the charge compensation circuit 206 instead of the reference capacitor Cref, no voltage drop occurs on the ESD resistor coupled to the reference capacitor Cref. The power loss is low.

As shown, the low-pass circuit (204) further comprises a reference resistor Rref, which couples the reference voltage Vref to the reference capacitor Cref. The reference resistor Rref and the reference capacitor Cref form a low-pass filter. The low-pass filter may provide a corner frequency lower than an interest frequency of a device using the CDAC 202. For audio applications, the audio band is from 20 Hz to 20,000 Hz. The corner frequency of the low-pass filter formed by Cref and Rref may be lower than 20 Hz. Thus, the noise affecting the audio is effectively suppressed.

For a more stable reference input Vref_dac, the reference voltage generator shown in FIG. 4 further provides a buffer buf_1 to couple the reference voltage Vref to the low-pass filter (Rref and Cref). Note that in this exemplary embodiment, the reference voltage Vref is coupled to the reference input terminal Vref_dac through the buffer buf_1 and the low-pass filter (Rref+Cref) without using any switch. This also helps maintain the voltage at the reference input terminal Vref_dac without ripples.

There is another buffer buf_2 shown in FIG. 4, which couples the reference voltage Vref to charge the capacitor networks 402_0-402_M. Through the buffer buf_2, the reference voltage Vref charges capacitor networks 402_0-402_M by an improved charging capability.

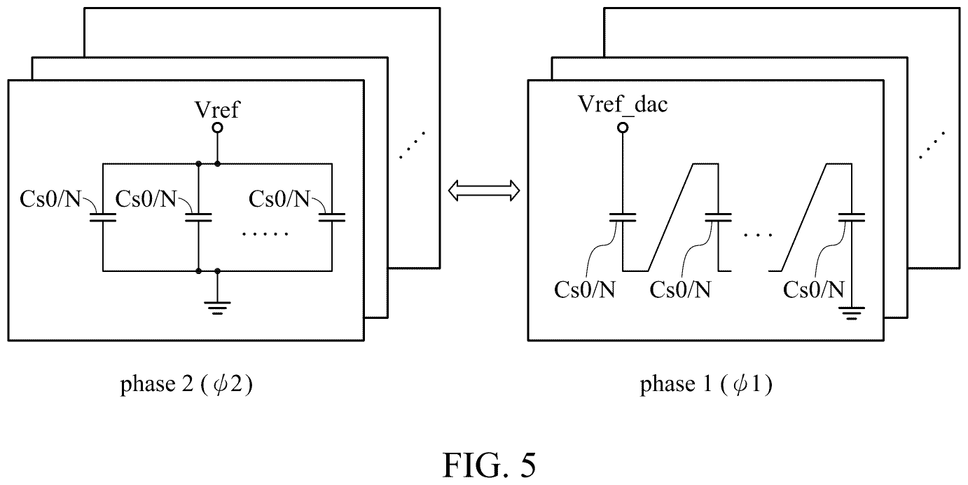

FIG. 5 illustrates the details of the capacitor networks 402_0 . . . 402_M in accordance with an exemplary embodiment of the disclosure. N is an integer greater than 1. Each capacitor network 402_# comprises N capacitors, wherein the capacitance of each capacitor is Cs0/N. When coupled to the reference voltage Vref to be charged by the reference voltage Vref (in the second phase ψ2), the N capacitors are connected in parallel. When coupled to the reference input terminal Vref_dac of the CDAC 202 to provide the reinforced voltage to the reference input terminal Vref_dac of the CDAC 202 (in the first phase ψ1), the N capacitors are connected in series. In an exemplary embodiment, the CDAC 202 includes a switched capacitor circuit that provides a variable capacitance in units of a capacitance unit, Cu. The ratio CsO/Cu is N²/(N−1). For example, when N is 2, the total capacitance, CsO, of the N capacitors in the same capacitor network 402_# is 4Cu.

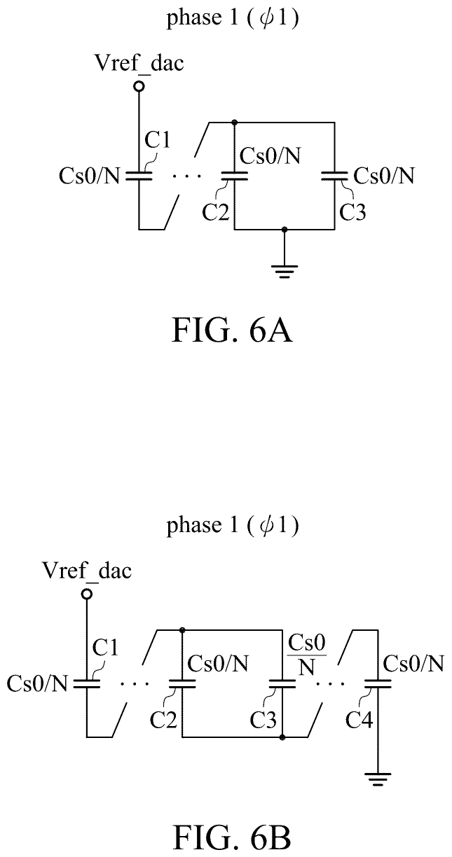

FIGS. 6A and 6B illustrate the other structures of the capacitor network in the first phase (ψ1). In FIG. 6A, one capacitor network comprising a first capacitor C1, a second capacitor C2, and a third capacitor C3 and operated in the first phase (ψ1) is shown. In the first phase ψ1 (FIG. 6A), the capacitors form a series-parallel structure to generate a reinforced voltage coupled to the reference input terminal Vref_dac of the CDAC 202. The first capacitor C1 and the second capacitor C2 are connected in series, and the second capacitor C2 is further connected in parallel with the third capacitor C3. In the second phase ψ2, the first capacitor C1, second capacitor C2, and third capacitor C3 are connected in parallel. FIG. 6B shows that a series-parallel-series structure also works well. In addition to the capacitors C1, C2, and C3, a capacitor network of FIG. 6B further has a fourth capacitor C4 connected in series with the parallel-connected capacitors C2 and C3. The capacitor network can be any capacitor array which can be switched to provide a reinforced voltage (greater than the reference voltage Vref) for the first phase (ψ1) operation.

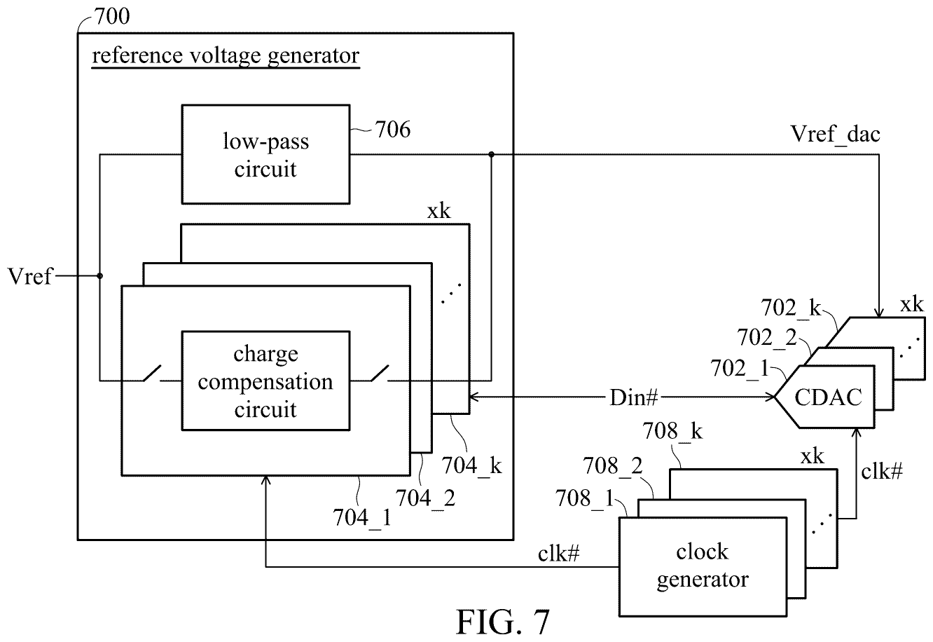

To provide the reference input Vref_dac to multiple CDACs, multiple charge compensation circuits are required. FIG. 7 illustrates a reference voltage generator 700 in accordance with an exemplary embodiment of the disclosure. There are K CDACs 702_1, 702_2, . . . 702_k, which are paired with K charge compensation circuits (with the phase control switches) 704_1, 704_2, . . . 704_k. The control bits Din_# controlling the number # CDAC (702_#) also controls the number # charge compensation circuit (704_#). However, the low-pass circuit 706 is shared by the K charge compensation circuits 704_1, 704_2, . . . 704_k. For example, the same set of buffer buf_1, reference resistor Rref and reference capacitor Cref providing the dc part of the reference input Vref_dac is shared by the different charge compensation circuits 7041, 704_2, . . . 704_k. The off-chip design will not be too large. In FIG. 7, multiple clock generators 708_1, 708_2, . . . , 708_k are provided to correspond to the multiple CDACs 7021, 702_2, . . . 702_k. The clock signal clk # controlling the number #CDAC (702_#) also controls the phase switching of the number # charge compensation circuit (704_#).

FIG. 7 shows that the output terminal of the low-pass circuit 706 is coupled to the reference input terminals Vref_dac of CDACs 702_1, 702_2, . . . 702_k. In addition to the charge compensation circuit 7041 designed for the CDAC 702_1, the reference voltage generator 700 further comprises charge compensation circuits 704_2 . . . 704_k, which are operative to be coupled to the reference input terminals Vref_dac of the CDACs 702_2 . . . 702_k, respectively, for charge compensation (supplying reinforced voltages greater than the reference voltage Vref). The charge compensation circuits 704_1 . . . 704_k are all charged by the reference voltage Vref.

In the number # charge compensation circuit 704_#, there are a plurality of capacitor networks, wherein, each capacitor network corresponds to one control bit of the control bits Din_# of the CDAC 702_#. In response to assertion of one control bit of the control bits Din_# of the CDAC 702_#, the corresponding capacitor network of the charge compensation circuit 704_# is coupled to the reference input terminal Vref_dac of the CDAC 702_# for charge compensation, and then is coupled back to the reference voltage Vref to be charged back to the reference voltage Vref.

The number # charge compensation circuit 704_# is switched to be coupled to the reference input terminal Vref_dac of the CDAC 702_# in response to the rising edge of the clock signal clk #, and then is switched back to be charged by the reference voltage Vref.

In some other exemplary embodiments, the different CDACs are paired not only with different charge compensation circuits, but also with different low-pass circuits.

Based on the above concept, the reference input Vref_dac generated for CDAC has characteristics of low noise and fast settling.

In an exemplary embodiment, the first phase ψ1 is further subdivided into a first sub-phase ψ1a and a second sub-phase ψ1b, to provide the reinforced voltage in steps, and make the reinforced voltage being within a safe range.

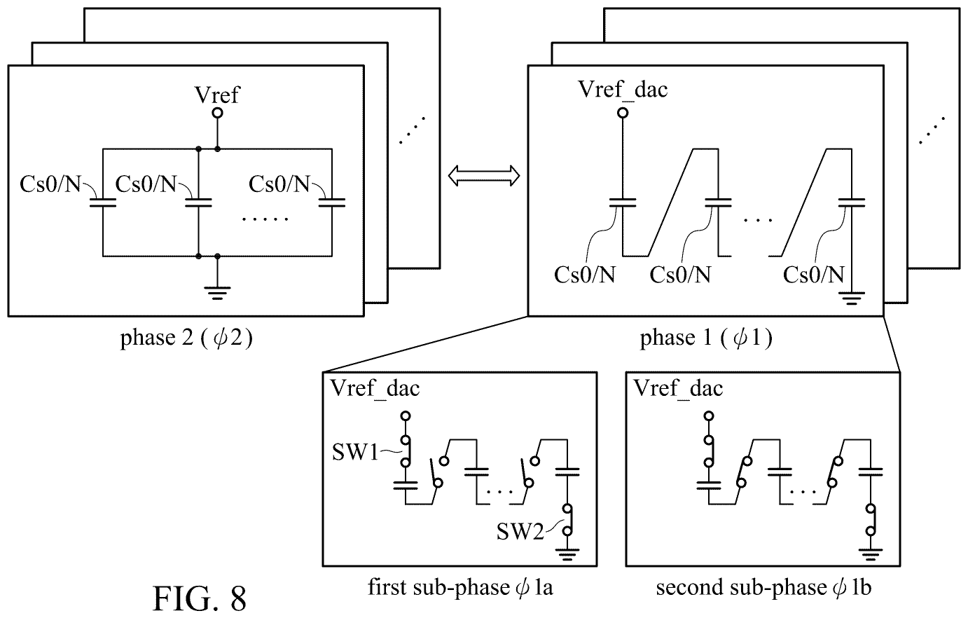

FIG. 8 illustrates the details of the capacitor networks 402_0 . . . 402_M in accordance with another exemplary embodiment of the disclosure. The first phase ψ1 is further subdivided into a first sub-phase ψ1a and a second sub-phase ψ1b. In an exemplary embodiment, after the first sub-phase ψ1a, there may be a delay, and then the control enters the second sub-phase ψ1b. In the first sub-phase ψ1a, the first switch SW1 coupled between the capacitor network and the reference input Vref_dac and the second switch SW2 coupled between the capacitor network and the power ground Vss are short, but the other switches coupled between the capacitors are open. In the second sub-phase ψ1b, the first switch SW1 is kept closed to connect the capacitor network to the reference input Vref_dac, the second switch SW2 is kept closed to connect the capacitor network to the power ground Vss, and the other switches coupled between the capacitors are also closed. By connecting the capacitors in series between Vref_dac and Vss by two steps (the first sub-phase ψ1a and the second sub-phase ψ1b), the reinforced voltage supplied to the reference input Vref_dac is controlled within a safe range without breaking the components of the CDAC 202.

Referring to the capacitor networks introduced in FIG. 6A or FIG. 6B, the two sub-phase ψ1a and ψ1b also work well. In an exemplary embodiment, one capacitor network comprises a plurality of capacitors, which are coupled in parallel to be charged by the reference voltage in the second phase ψ2. In the first sub-phase ψ1a of the first phase ψ1, a first switch SW1 between the plurality of capacitors and the reference input Vref_dac and a second switch SW2 between the plurality of capacitors and a power ground Vss are closed, but connections between the plurality of capacitors are broken. In the second sub-phase ψ1b of the first phase ψ1, the first switch SW1 between the plurality of capacitors and the reference input Vref_dac and the second switch SW2 between the plurality of capacitors and the power ground Vss are closed, and the plurality of capacitors are connected between the reference input Vref_dac and the power ground Vss through the closed first switch SW1 and second switch SW2 with at least two capacitors between the plurality of capacitors are connected in series.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A reference voltage generator, comprising:
a low-pass circuit, having an input terminal receiving a reference voltage, and an output terminal coupled to a first reference input terminal of a first capacitive digital-to-analog converter; and
a first charge compensation circuit, coupled to the first reference input terminal of the first capacitive digital-to-analog converter in a first phase to compensate for charge losses of the first capacitive digital-to-analog converter, and coupled to the reference voltage in a second phase to be charged by the reference voltage,
wherein the first charge compensation circuit coupled to the first reference input terminal of the first capacitive digital-to-analog converter in the first phase provides a first reinforced voltage to the first reference input terminal of the first capacitive digital-to-analog converter, and the first reinforced voltage is greater than the reference voltage.

2. The reference voltage generator as claimed in claim 1, wherein:
the first charge compensation circuit comprises a plurality of capacitor networks, and each capacitor network corresponds to one control bit of a plurality of control bits of the first capacitive digital-to-analog converter; and
in response to assertion of one control bit of the plurality of control bits of the first capacitive digital-to-analog converter, the corresponding capacitor network is coupled to the first reference input terminal of the first capacitive digital-to-analog converter, and then is coupled back to the reference voltage.

3. The reference voltage generator as claimed in claim 2, wherein:
one capacitor network comprises N capacitors, where N is an integer greater than 1;
when coupled to the reference voltage to be charged by the reference voltage, the N capacitors are connected in parallel; and
when coupled to the first reference input terminal of the first capacitive digital-to-analog converter to provide the first reinforced voltage to the first reference input terminal of the first capacitive digital-to-analog converter, the N capacitors are connected in series.

4. The reference voltage generator as claimed in claim 3, wherein:
the first capacitive digital-to-analog converter includes a switched capacitor circuit, wherein the switched capacitor circuit provides a variable capacitance in units of a capacitance unit, Cu;
capacitance of each of the N capacitors is CsO/N; and
CsO/Cu is N²/(N−1).

5. The reference voltage generator as claimed in claim 2, wherein:
one capacitor network comprises a plurality of capacitors, which are coupled in parallel to be charged by the reference voltage in the second phase;
the first phase is further subdivided into a first sub-phase and a second sub-phase;
in the first sub-phase of the first phase, a first switch between the plurality of capacitors and the first reference input terminal and a second switch between the plurality of capacitors and a power ground are closed, but connections between the plurality of capacitors are broken; and
in the second sub-phase of the first phase, the first switch between the plurality of capacitors and the first reference input terminal and the second switch between the plurality of capacitors and the power ground are closed, and the plurality of capacitors are connected between the first reference input terminal and the power ground through the closed first switch and second switch with at least two capacitors between the plurality of capacitors are connected in series.

6. The reference voltage generator as claimed in claim 2, wherein:
one capacitor network comprises a first capacitor, a second capacitor, and a third capacitor;
when coupled to the reference voltage to be charged by the reference voltage, the first capacitor, second capacitor, and third capacitor are connected in parallel; and
when coupled to the first reference input terminal of the first capacitive digital-to-analog converter to provide the first reinforced voltage to the first reference input terminal of the first capacitive digital-to-analog converter, the first capacitor and the second capacitor are connected in series, and the second capacitor is further connected in parallel with the third capacitor.

7. The reference voltage generator as claimed in claim 2, wherein:
the low-pass circuit comprises a reference capacitor, wherein the reference capacitor is charged by the reference voltage, and is further coupled to the first reference input terminal of the first capacitive digital-to-analog converter.

8. The reference voltage generator as claimed in claim 7, wherein:
the reference capacitor is an off-chip capacitor, providing capacitance greater than capacitance of the capacitor networks which use on-chip capacitors.

9. The reference voltage generator as claimed in claim 7, wherein:
the low-pass circuit further comprises a reference resistor, wherein the reference resistor couples the reference voltage to the reference capacitor; and
the reference resistor and the reference capacitor form a low-pass filter.

10. The reference voltage generator as claimed in claim 9, wherein:
the low-pass filter provides a corner frequency lower than an interest frequency of a device using the first capacitive digital-to-analog converter.

11. The reference voltage generator as claimed in claim 9, further comprising:
a buffer, coupling the reference voltage to the low-pass filter.

12. The reference voltage generator as claimed in claim 2, further comprising:
a buffer, coupling the reference voltage to charge the capacitor networks.

13. The reference voltage generator as claimed in claim 1, wherein:
the first capacitive digital-to-analog converter includes a switched capacitor circuit which is controlled based on a clock signal; and
the first phase starts in response to a rising edge of the clock signal, and is followed by the second phase.

14. The reference voltage generator as claimed in claim 1, wherein:
the output terminal of the low-pass circuit is further coupled to a second reference input terminal of a second capacitive digital-to-analog converter; and
the reference voltage generator further comprises a second charge compensation circuit that is operative to be coupled to the second reference input terminal of the second capacitive digital-to-analog converter to compensate for charge losses of the second capacitive digital-to-analog converter, wherein the second charge compensation circuit is charged by the reference voltage.

15. The reference voltage generator as claimed in claim 14, wherein:
when coupled to the second reference input terminal of the second capacitive digital-to-analog converter, the second charge compensation circuit provides a second reinforced voltage to the second reference input terminal of the second capacitive digital-to-analog converter, and the second reinforced voltage is greater than the reference voltage.

16. The reference voltage generator as claimed in claim 15, wherein:
the first charge compensation circuit and the second charge compensation circuit each comprises a plurality of capacitor networks, wherein each capacitor network of the first charge compensation circuit corresponds to one control bit of a plurality of control bits of the first capacitive digital-to-analog converter, and each capacitor network of the second charge compensation circuit corresponds to one control bit of a plurality of control bits of the second capacitive digital-to-analog converter;
in response to assertion of one control bit of the plurality of control bits of the first capacitive digital-to-analog converter, the corresponding capacitor network of the first charge compensation circuit is coupled to the first reference input terminal of the first capacitive digital-to-analog converter, and then is coupled back to the reference voltage; and
in response to assertion of one control bit of the plurality of control bits of the second capacitive digital-to-analog converter, the corresponding capacitor network of the second charge compensation circuit is coupled to the second reference input terminal of the second capacitive digital-to-analog converter, and then is coupled back to the reference voltage.

17. The reference voltage generator as claimed in claim 15, wherein:
the first capacitive digital-to-analog converter includes a first switched capacitor circuit which is controlled based on a first clock signal;
the second capacitive digital-to-analog converter includes a second switched capacitor circuit which is controlled based on a second clock signal;
the first charge compensation circuit is switched to be coupled to the first reference input terminal of the first capacitive digital-to-analog converter in response to a rising edge of the first clock signal, and then is switched back to be charged by the reference voltage; and
the second charge compensation circuit is switched to be coupled to the second reference input terminal of the second capacitive digital-to-analog converter in response to a rising edge of the second clock signal, and then is switched back to be charged by the reference voltage.
